(19) United States
(12) Patent Application Publication
(10) Pub. No.: US 2007/0125176 A1
(43) Pub. Date: Jun. 7, 2007

(54) Energy harvesting device and methods

(75) Inventor: Yue Liu, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/292,615

(22) Filed: Dec. 2, 2005

(51) Int. Cl. G01H 13/00; G01H 11/00

(52) U.S. Cl. 73/649; 73/579

(57) ABSTRACT

An energy harvesting device and related methods, with one embodiment comprising a micro-electromechanical structure fabricated as a plurality of members respectively resonant at different frequencies so that the structure can respond to a number of different vibration frequencies. Piezoelectric material converts the vibrations into an electric voltage difference across at least a portion of the structure.

### FIELD OF THE INVENTION

This invention pertains to an energy harvesting device and related methods.

### BACKGROUND

In general, it is known that piezoelectric materials produce electric charges on parts of their surfaces when they are under (compressive or tensile) strain in particular directions, and that the charge disappears when the pressure is removed. The mechanical stress produces an electric polarization that is proportional to the stress. This polarization manifests itself as a voltage across the piezoelectric material. The relationship between the electric polarization and the mechanical stress along a particular axis is known in the art. These piezoelectric materials are used in electromechanical transducers that can convert mechanical energy to electrical energy.

As is known in the art, appropriate electric connections can be made to the piezoelectric material to capture the electric energy. The particular positions of the electrodes with respect to the piezoelectric material would depend on the particular piezoelectric material. That is, the captured electrical energy can be maximized with different orientations of the electrodes (relative to the axis being mechanically stressed), depending on the particular piezoelectric material.

The relationships between resonant frequency and the physical characteristics of a particular structure are also known in the art.

It is known in the art that electronic systems can be realized from extremely small electronic parts. In particular, a micro-electromechanical structure (MEMS) can be fabricated using known integrated circuit manufacturing technology. For example, a silicon-based resonating structure can be fabricated with a piezoelectric surface film.

A simple MEMS resonator structure typically responds to a single frequency or a narrow frequency band that is much higher than most of the frequencies of common ambient vibration sources.

### BRIEF DESCRIPTION OF THE DRAWINGS

The figures are not necessarily to scale.

FIG. 1 is a top view of a prototype chip showing about twenty beams of different dimensions.

FIG. 2a is a demonstrative graphic representation of the amplitude of a possible source vibration versus time.

FIG. 2b is a demonstrative graphic representation of the amplitude of a possible source vibration versus frequency.

FIG. 2c is a demonstrative graphic representation of responses of vibration amplitude versus frequency of an energy harvesting device tuned to the characteristic frequencies of the source represented by FIG. 2b.

FIG. 3a is a top view of schematic drawing of a four-beam array, with a representation of measuring current that may flow between electrodes for each beam, respectively.

FIG. 3b is a partial cross-sectional view taken along line 3b-3b of FIG. 3a.

FIG. 3c is a demonstrative graphic representation of current amplitude versus time for currents that may flow between electrodes for each beam, respectively, in FIG. 3a.

FIG. 4a is a top view of a schematic drawing of a four-beam array, with an electric circuit representation of a rectifying circuit electrically coupled across electrodes for each beam, respectively, on the same chip, and a load is shown in phantom as an output.

FIG. 4b is a partial cross-sectional view taken along line 4b-4b of FIG. 4a.

FIG. 4c is a demonstrative graphic representation of current amplitude versus time for currents that may flow respectively from each of the rectifying circuits represented in FIG. 4a.

FIG. 4d is a demonstrative graphic representation of current amplitude versus time for the total current that may flow from the four rectifying circuits (represented in FIG. 4a) connected in parallel.

### DETAILED DESCRIPTION

While the present invention is susceptible of embodiment in various forms, there is shown in the drawings and described below some embodiments with the understanding that the present disclosure is to be considered an exemplification of the invention and is not intended to limit the invention to the specific embodiments illustrated or described.

An example of an energy harvesting device that embodies the invention is a resonating structure designed to respond to source vibration energy. It may be designed to include resonant frequencies corresponding with specific frequencies anticipated to be characteristic of a particular source or particular sources. It also may be designed to include resonant frequencies within the range of miscellaneous ambient noise. The energy harvesting device includes piezoelectric material capable of converting vibrations into an electric voltage difference across the device.

The energy harvesting device captures energy that otherwise would be dissipated and not used productively. It is especially valuable to power, or at least to provide supplementary power, in circumstances in which it is desirable to avoid wire connections. For example, a wireless sensor, a remote indicator, and similar devices can be powered by an energy harvesting device, avoiding the need to bring in wiring or to replace batteries. Similarly, an energy harvesting device can supplement other power sources such as batteries or solar power sources. In that way, for example, a battery would not have to be replaced as frequently. As another example, power for solar-powered roadside indicators can be supplemented by energy harvesting devices tuned to one or more frequencies within the frequency ranges of ambient road noises.

As an example, a MEMS device can be fabricated with a plurality of resonating members. The geometry of the different members can be designed for different resonant frequencies, in order to respond to broad spectra of ambient vibration frequencies. For example, a MEMS device that embodies the invention can be fabricated as an array of resonant beams. For example, such a structure can be fabricated using a wafer-scale batch process as is known in the art, and the microstructure nature of the devices allows them to have very flexible design room (to accomplish the desired frequency response) without a significant impact on the form-factor.

Typically, MEMS resonant beams would not exceed about 10 millimeters in length. This makes it more challenging to achieve low frequencies such as those less than about one kilohertz as might be typical of most miscellaneous ambient noise. However, those low frequencies can be achieved using a thinner beam or a heavier proof mass at the end of the beam.

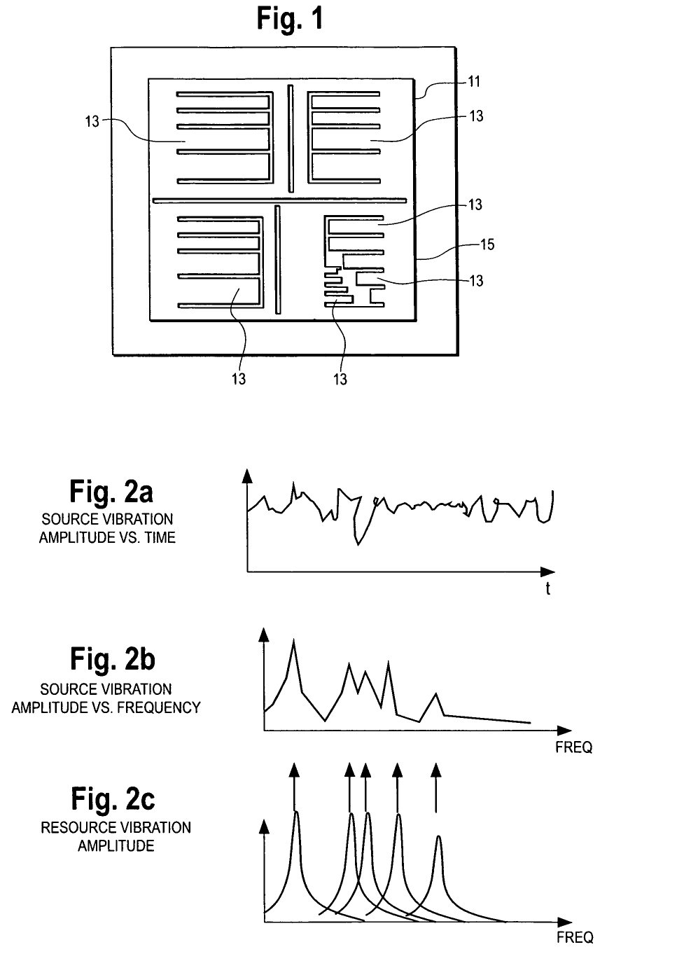

FIG. 1 shows a prototype chip 11 cut from a wafer with about twenty beams 13 of different dimensions, each designed to resonate at a certain frequency. The chip 11 includes a piezoelectric material surface film 15. In practice, specific resonant frequencies can be selected based on a particular application. For example, the device may be designed in conjunction with a wireless sensor for use with particular equipment. Characteristic frequencies of that particular equipment would be considered when designing the energy harvesting device. As the manufacturing expense generally does not increase significantly with more vibrating members, specific resonant frequencies can be selected so that the same device can be used in different applications with different source vibration frequencies. Furthermore, some resonant frequencies can be selected without a particular source anticipated, but within the ranges of most miscellaneous ambient noise.

FIG. 2a is a demonstrative graphic representation of the amplitude of a possible source vibration versus time, and FIG. 2b is a demonstrative graphic representation of the amplitude of a possible vibration source versus frequency. The FIG. 2b presentation shows five frequency peaks, characteristic of the contemplated vibration source. An energy harvesting device, designed for an application near that source, could be tuned to have five resonant frequencies corresponding with the five peak frequencies characteristic of the contemplated vibration source. FIG. 2c is a demonstrative graphic representation of the response vibration amplitude versus frequency of such a tuned energy harvesting device.

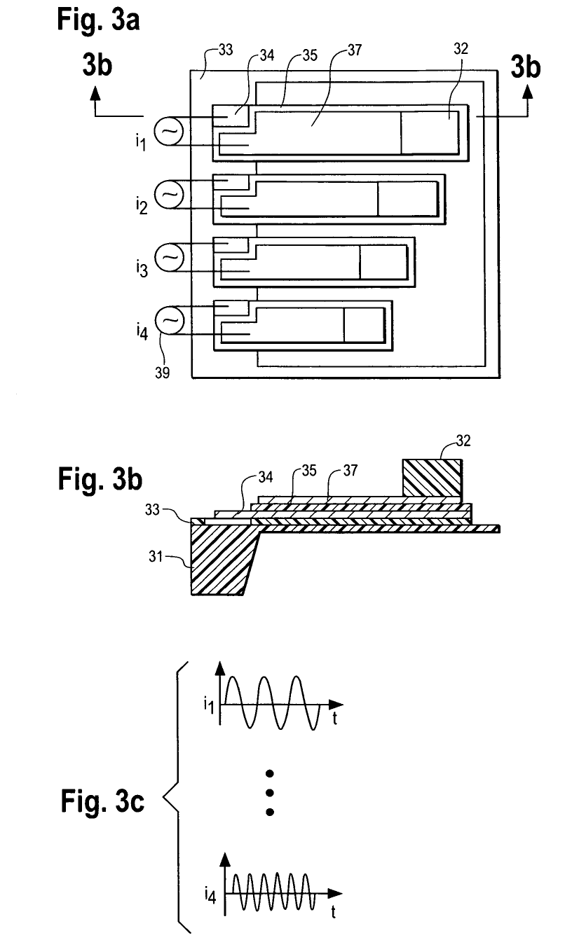

In one example, a MEMS-based energy harvesting device may comprise an array of beams that resonate at different frequencies. FIG. 3a is a top view of a schematic drawing (not to scale) of a four-beam array, and FIG. 3b is a partial cross sectional view taken along line 3b-3b of FIG. 3a. The FIG. 3a/3b example shows a silicon base 31 with a proof mass 32 at the end of each of the resonating beams. The top of each beam is coated with a piezoelectric film 35, with a bottom electrode 34 between the piezoelectric film 35 and an insulating dielectric layer 33 above the base 31, and with a top electrode 37 above the piezoelectric film 35. FIG. 3a also shows a representation 39 of measuring current that may flow between electrodes 34 and 37 for each beam, respectively. FIG. 3c is a demonstrative graphic representation of current amplitude versus time for currents i₁ through i₄ that may flow between electrodes 34 and 37 for each beam, respectively, in FIG. 3a.

As an example of fabricating such a MEMS-based array of beams, a typical process can start with a silicon wafer with silicon dioxide (SiO₂) layers (typically about 2 micrometers thick) formed on the top and bottom sides using a wet oxidization process. Bottom electrodes can then be formed on the top side, by deposition of titanium (Ti) and platinum (Pt) layers using a sputtering process, followed by an optional electrode patterning step. The Ti is typically about 50 nanometers thick and serves as an adhesion layer, and the electrode metal Pt is typically a few hundred nanometers thick. Next, a piezoelectric film (typically 0.1 to 5 micrometers thick) is deposited. For example, three micrometers of Lead Zirconate Titanate (PZT) films can be deposited by repeated sol-gel processes. The top electrodes can then be deposited on top of the piezoelectric film by same process as was used for the bottom electrodes. The top-side device patterns of the top electrodes, the piezoelectric film, the bottom electrodes, and the resonant beam elements can be formed subsequently by using standard photolithography patterning techniques and a combination of wet and/or dry etch processes. Optional proof masses can be fabricated at wafer scale using processes such as a UV-LIGA or an SU-8 process combined with metal (such as nickel (Ni)) plating.

After the top-side process, the top side can be protected before proceeding to a bottom-side process of selectively removing bulk silicon (Si) from the bottom to form the cantilever beam resonators with desired thicknesses. A typical method used for such a Si micromachining step is to pattern the SiO₂ on the bottom-side, and then to etch the exposed Si regions using wet chemical (such as potassium hydroxide (KOH)) solutions.

As the different resonating frequencies of different beams illustrated in the example of FIG. 3a/3b may well be out of phase, separate rectifying circuitry could be used for each beam in order to maximize the capture and possible storage of the electrical energy. This could be achieved most economically using integrated circuit fabrication technology. For example, multiple rectifying circuits could be incorporated into the same silicon substrate with the resonating beams.

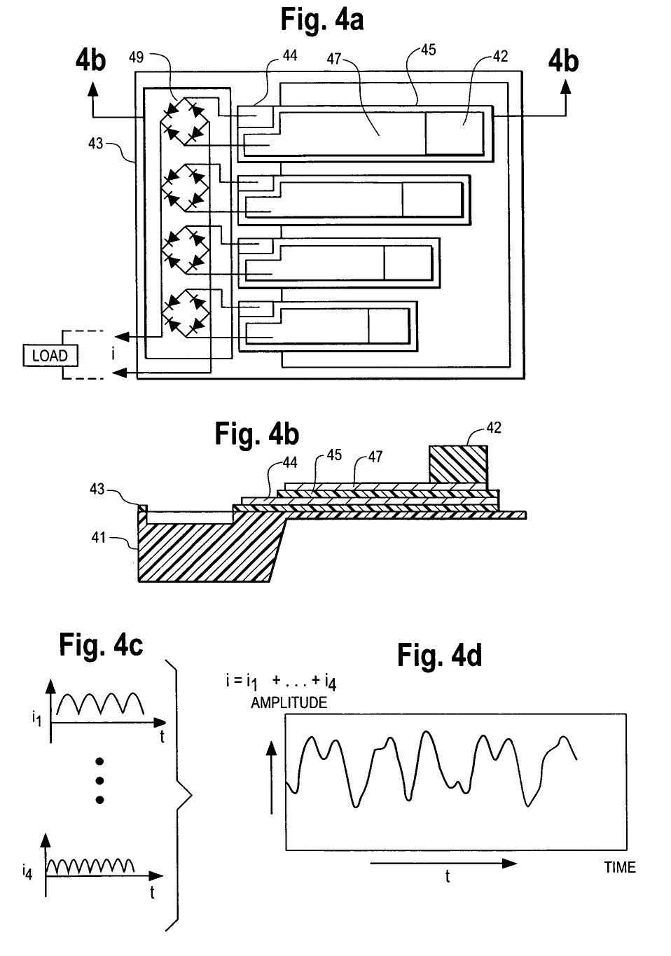

As an example, FIG. 4a is a top view of a schematic drawing (not to scale) of a four-beam array, with an electric circuit representation of a rectifying circuit electrically coupled across electrodes for each beam, respectively, and FIG. 4b is a partial cross-sectional view taken along line 4b-4b of FIG. 4a. The FIG. 4a/4b example shows a silicon base 41 with a proof mass 42 at the end of each of the resonating beams. The top of each beam is coated with a piezoelectric film 45, with a bottom electrode 44 between the piezoelectric film 45 and an insulating dielectric layer 43 above the base 41, and with a top electrode 47 above the piezoelectric film 45. FIG. 4a also shows an electric circuit representation of a rectifying circuit 49 incorporated into the base 41 for each of the resonating beams.

FIG. 4c is a demonstrative graphic representation of current amplitude versus time for currents i, through i, that may flow respectively from each of the rectifying circuits 49 represented in FIG. 4a. FIG. 4d is a demonstrative graphic representation of current amplitude versus time for the total current i that may flow from the four rectifying circuits 49 represented in FIG. 4a, where the current i would be the sum of currents i₁ through i₄. A load is shown in phantom in FIG. 4a.

FIG. 4a represents an example of an embodiment of the invention. A different number of beams, and other resonating shapes, come within the true spirit and scope of the invention.

From the foregoing it will be observed that modifications and variations can be effectuated without departing from the true spirit and scope of the novel concepts of the present invention. It is to be understood that no limitation with respect to specific embodiments shown or described is intended or should be inferred.

What is claimed is:

1. An energy harvesting device comprising:
piezoelectric material capable of converting vibrations into an electric voltage difference across at least a portion of the device;
a plurality of members;
a first member of the plurality of members resonant at a first frequency;
a second member of the plurality of members resonant at a second frequency that is different than the first frequency.

2. The energy harvesting device as in claim 1,
the plurality of members comprising at least three members;
each of the members respectively resonant at a different frequency than the frequencies at which the other members are resonant.

3. The energy harvesting device as in claim 1, wherein the first frequency does not exceed about one kilohertz.

4. The energy harvesting device as in claim 1, wherein no linear dimension of any of the members exceeds about ten millimeters.

5. The energy harvesting device as in claim 1, wherein the plurality of members comprises an array of beams.

6. The energy harvesting device as in claim 1, wherein each of the plurality of members is composed at least partially of silicon.

7. The energy harvesting device as in claim 1, wherein the piezoelectric material comprises a surface film on at least part of the device.

8. The energy harvesting device as in claim 1, further comprising:
a first rectifying circuit;
a second rectifying circuit;
the first rectifying circuit electrically coupled with the first member;
the second rectifying circuit electrically coupled with the second member.

9. A method for making an energy harvesting device, the method comprising:
creating a micro-electromechanical array of beams using integrated circuit manufacturing technology;
designing each of the beams to be resonant respectively at a different frequency than the frequencies at which the other beams are resonant;
coating at least part of each of the beams with a piezoelectric material capable of converting vibrations into an electric voltage difference across at least a portion of the array.

10. The method as in claim 9, further comprising:
electrically coupling the piezoelectric material coating of each beam to a separate rectifying circuit.

11. The method as in claim 10, further comprising:
integrating the rectifying circuits and the array of beams on a single chip.

12. The method as in claim 9, wherein the array comprises at least three beams.

13. The method as in claim 9, wherein a resonant frequency of a first beam of the array does not exceed about one kilohertz.

14. The method as in claim 9, wherein none of the beams is longer than about ten millimeters.

15. The method as in claim 9, wherein the array is composed at least partially of silicon.

16. The method as in claim 9, wherein
the creating process comprises forming silicon dioxide layers on a top and a bottom of a silicon wafer using a wet oxidation process;
the coating process comprises depositing the piezoelectric material on the top by repeated sol-gel processes;
the creating process further comprises using a sputtering process to deposit a bottom electrode on the top silicon dioxide layer before performing the coating step, and to deposit a top electrode after performing the coating step;
the creating process further comprises forming top-side device patterns using photolithography patterning techniques and etch processes;
the creating process further comprises selectively removing bulk silicon from the bottom of the wafer to form the beams with desired thicknesses.

17. A method for supplying electric energy to a system, the method comprising:
electrically connecting the system to a micro-electromechanical structure (MEMS);
the MEMS comprising a plurality of members;
each member of at least some of the plurality of members being resonant respectively at a different frequency than the frequencies at which the other members are resonant;
the MEMS comprising piezoelectric material capable of converting vibrations at any of the resonant frequencies into an electric voltage difference across at least a portion of the MEMS.

18. The method as in claim 17, further comprising:
separately rectifying a voltage across any of the plurality of members.

19. The method as in claim 17, wherein the plurality of members comprises at least three members.

20. The method as in claim 17, wherein a resonant frequency of a first member of the plurality of members does not exceed about one kilohertz.

21. The method as in claim 17, wherein no linear dimension of any of the members exceeds about ten millimeters.

22. The method as in claim 17, wherein the plurality of members comprises an array of beams.

23. The method as in claim 17,
each of the plurality of members being composed at least partially of silicon;
the piezoelectric material comprising a surface film on at least part of the MEMS.

24. An energy harvesting device comprising:
a micro-electromechanical means for resonating at a number of different vibration frequencies;
a means for converting vibrations into an electric voltage difference across at least a portion of the device.

25. The energy harvesting device as in claim 24,
the resonating means comprising at least three members;
each of at least some of the members respectively resonant at a different frequency than the frequencies at which the other members are resonant.

26. A sensor for sensing a desired parameter, the sensor comprising:
a sensing member capable of sensing the desired parameter;
a plurality of vibrating members;
each member of at least some of the plurality of vibrating members being resonant respectively at a different frequency than the frequencies at which the other vibrating members are resonant;
piezoelectric material capable of converting vibrations at any of the resonant frequencies into an electric voltage difference across at least a portion of the sensor, and providing electric energy for operation of the sensor.

27. The sensor as in claim 26, further comprising:
a battery;
the energy provided by the piezoelectric material capable of supplementing energy available from the battery.

28. The sensor as in claim 26, wherein a resonant frequency of a first vibrating member of the plurality of resonant members does not exceed about one kilohertz.

29. The sensor as in claim 26, wherein no linear dimension of any of the vibrating members exceeds about ten millimeters.

30. The sensor as in claim 26, wherein the plurality of vibrating members comprises an array of beams.

31. The sensor as in claim 26,
each of the plurality of vibrating members being composed at least partially of silicon;
the piezoelectric material comprising a surface film on at least part of the sensor.

32. The sensor as in claim 26, further comprising:
a plurality of rectifying circuits;
each rectifying circuit electrically coupled respectively with one of the plurality of vibrating members.
